(19) United States
(12) Patent Application Publication
(10) Pub. No.: US 2026/0200709 A1
(43) Pub. Date: Jul. 16, 2026

(54) METHOD FOR LIFTING AND TRANSPORTING A LOAD USING AN AUTONOMOUS FORKLIFT TRUCK

(71) Applicant: COMPAGNIE GENERALE DES ETABLISSEMENTS MICHELIN, Clermont-Ferrand (FR)

(72) Inventors: YANN BINDA, Clermont-Ferrand (FR); FLORIAN FAURE, Clermont-Ferrand (FR); KEVIN BOUVET, Clermont-Ferrand (FR)

(21) Appl. No.: 19/137,791

(22) PCT Filed: Dec. 4, 2023
(86) PCT No.: PCT/FR2023/051916

§ 371 Date: Jun. 11, 2025

(30) Foreign Application Priority Data
Dec. 14, 2022 (FR) FR2213358

(51) Int. Cl. B66F 9/06; B66F 9/075; G05D 1/225; G05D 1/667; G05D 105/28; G06Q 10/087; G06T 7/62

(52) U.S. Cl. CPC B66F 9/063; B66F 9/0755; G05D 1/225; G05D 1/667; G06Q 10/0877; G06T 7/62; G05D 2105/28; G06T 2207/10028

(57) ABSTRACT

This method (20) for lifting and transporting a load comprises:
a step (21) of the forklift receiving a mission comprising a theoretical value of at least one dimension of said load;
a step (22) of moving the forklift so that it is in front of the load to be lifted and transported;
step (23) of acquiring at least one image of the load by means of at least one camera fastened to the forklift;
a step (24) of determining an actual value of said dimension of the load on the basis of said image obtained in the acquisition step;
a step (26) of comparing the actual value and the theoretical value of said dimension, and
a step (27) of stopping the forklift if the difference between the actual value of said dimension and the theoretical value thereof is greater, as an absolute value, than a predefined limit value.

### TECHNICAL FIELD

The present invention relates to the field of autonomous vehicles for the automated transportation of loads, such as autonomous forklifts.

### PRIOR ART

Autonomous vehicles for transporting loads are increasingly being used to increase productivity and improve logistics management in factories or in warehouses.

Automated forklifts are one example of such vehicles and make it possible for example for a load to be loaded, transported and positioned at height without human intervention.

However, in environments such as factories or warehouses, human intervention is still required in addition to the automated operations, for example to control the satisfactory progress of these operations or to perform tasks that cannot be carried out by machines alone. These environments are therefore shared between humans and autonomous machines.

Personal safety is of fundamental importance in such working environments and accordingly requires that specific procedures be put in place.

For example, during operations to pick a load from storage shelving that can receive loads that are different, in particular in terms of dimensions, it is possible that the load actually present on the shelving does not match the load that should be picked by the autonomous forklift according to the mission assigned to it by a management system managing the flows in the warehouse.

In this case, there is the risk of an accident.

### DISCLOSURE OF THE INVENTION

In light of the above, the aim of the invention is to increase the safety of operations for lifting and transporting a load using an autonomous forklift.

The invention relates to a method for lifting and transporting a load using an autonomous forklift comprising a vertically movable fork provided with at least one arm.

The method comprises:
a step of the forklift receiving an assigned mission to move the load to be lifted and transported that comprises a theoretical value of at least one dimension of said load,
a step of moving the autonomous forklift so that it is in front of the load to be lifted and transported,
a step of acquiring at least one image of the load by means of at least one camera fastened to the autonomous forklift centred relative to the fork and having a line of sight oriented forwards along a longitudinal axis of said forklift,
a step of determining an actual value of said dimension of the load on the basis of said image obtained in the acquisition step,
a step of comparing the actual value of said dimension of the load determined in the determination step and the theoretical value of said dimension of the load received in the receiving step, and
a step of stopping the forklift if the difference between the actual value of said dimension and the theoretical value thereof is greater, as an absolute value, than a predefined limit value, or
a step of lifting and transporting the load if the difference between the actual value of said dimension and the theoretical value thereof is less than or equal to, as an absolute value, the predefined limit value.

Such a method makes it possible to increase the safety of operations by stopping the autonomous forklift before the load is picked if this load does not match the load in the mission assigned to the forklift.

Such a method makes it possible to increase the safety of operations by taking into account the actual values of the dimensions of the load to be transported. The method thus makes it possible to adapt the behaviour of the forklift on the basis of the loads to be transported in order to maintain personal safety.

The method thus makes it possible to check the consistency between the mission assigned to the forklift and the load actually present on the shelving before the lifting and transporting operations are carried out. The method thus makes it possible not to rely solely on the information in the mission assigned to the forklift for carrying out these operations.

According to a first embodiment, said camera is a 3D camera rendering a point cloud of coordinates measured in a coordinate system associated with said 3D camera, and the determination step comprises a step of digitally processing said image obtained in the acquisition step that comprises a sub-step of calculating the actual value of said dimension of the load.

According to an alternative second embodiment, the determination step comprises a step of reading a bar code on said image obtained in the acquisition step, and a step of extracting the actual value of said dimension of the load from a table contained in a memory of the forklift on the basis of the bar code read. For this alternative embodiment, said camera can be a 3D camera or another type of camera.

According to the first embodiment, it is for example possible that:
the load to be lifted and transported is annular,
the mission assigned in the receiving step comprises theoretical values of the depth and the outer diameter of the annular load,
the digital processing step comprises sub-steps of calculating the actual values of the depth and the outer diameter of the annular load,
the comparison step comprises comparing the actual value and the theoretical value of the depth of the load, and comparing the actual value and the theoretical value of the outer diameter of the load,
the step of stopping the forklift is carried out if the difference between at least one of said actual values and the theoretical value thereof is greater, as an absolute value, than a predefined limit value.

It can also be envisaged for example that:
the step of digitally processing said image obtained in the acquisition step comprises a sub-step of detecting a first inner circle located on a front face of the annular load and corresponding to the inner diameter of said annular load, and detecting a second inner circle located on a rear face of the annular load and corresponding to an inner surface of said load,
the actual value of the depth of the annular load is calculated on the basis of the diameter D₁₆ of the first inner circle, the diameter D₁₇ of the second inner circle, and the distance d between said 3D camera and the front face of the load, using the following equation:

$$P = d \times \frac{{D}_{16} - {D}_{17}}{{D}_{17}} \qquad ( Eq . 1 )$$

“Rear face” of the annular load is given to mean the frontal face of the load that is oriented on the opposite side from the 3D camera. “Front face” of the annular load is given to mean the frontal face of the load that is oriented on the same side as the 3D camera. The front and rear faces define the thickness of the load.

According to one feature, the actual value of the depth of the annular load is equal to the maximum difference between the coordinates of the points of an inner surface of the annular load between the inner circles, said difference being measured along the axis of the coordinate system oriented along the line of sight of said 3D camera.

According to another feature, the step of digitally processing said image obtained in the acquisition step comprises a sub-step of detecting a circle located on the front face of the annular load and corresponding to the outer diameter of the annular load.

For example, the acquisition step comprises the following successive sub-steps:
a first sub-step of acquiring at least one image;
a sub-step of advancing the forklift towards the load by a predefined distance; and
a second sub-step of acquiring at least one image carried out when the forklift has covered said predefined distance,
   and wherein the sub-step of calculating the actual value of the outer diameter of the annular load is carried out on the basis of the image obtained in the first acquisition sub-step, and the sub-step of calculating the actual value of the depth (P) of the annular load is carried out on the basis of the image obtained in the second acquisition sub-step.

Advantageously, the digital processing step comprises a sub-step of filtering said image obtained in the acquisition step that is carried out before any other sub-step of the digital processing step. This filtering sub-step makes it possible to reduce the amount of data to be processed by filtering the points of the images obtained in the acquisition step in order to keep only the points that form part of a region of particular interest. By limiting the calculations to the reduced areas of the region of particular interest, the method obtains results more quickly without adversely affecting the quality thereof. By limiting the data to the regions of interest, the size of the memory required for the command and digital image processing module associated with the 3D cameras is also reduced.

Preferably, the step of acquiring said image of the load is carried out by a single 3D camera. As a variant, the acquisition step can be carried out by a plurality of 3D cameras. As a variant, the acquisition step can be carried out by one or more non-3D cameras that can be used to read bar codes.

According to another aspect, the invention relates to an autonomous forklift comprising a vertically movable fork provided with at least one arm, at least one 3D camera for acquiring at least one point cloud data image, said 3D camera being fastened to the autonomous forklift centred relative to the fork and having a line of sight oriented forwards along a longitudinal axis of said forklift, a command and digital image processing module associated with the 3D camera, a wireless telecommunication device, and a unit for controlling said forklift configured to implement a method as described above.

### BRIEF DESCRIPTION OF THE FIGURES

Further aims, features and advantages of the invention will become apparent on reading the following description, which is given solely by way of non-limiting example, and with reference to the appended drawings, in which:

FIG. 1 is a perspective view of an autonomous forklift according to one exemplary embodiment of the invention;

FIG. 2 is a detailed view of the forklift in FIG. 1;

FIG. 3 schematically illustrates the forklift in FIG. 1, while it is in use;

FIG. 4 illustrates the flow diagram for a method for lifting and transporting a load using a forklift in FIG. 1 according to one embodiment of the invention; and

FIG. 5 is a simplified example of an image acquired by a camera of the forklift in FIG. 1 in the case of an annular load.

### DETAILED DESCRIPTION OF AT LEAST ONE EMBODIMENT

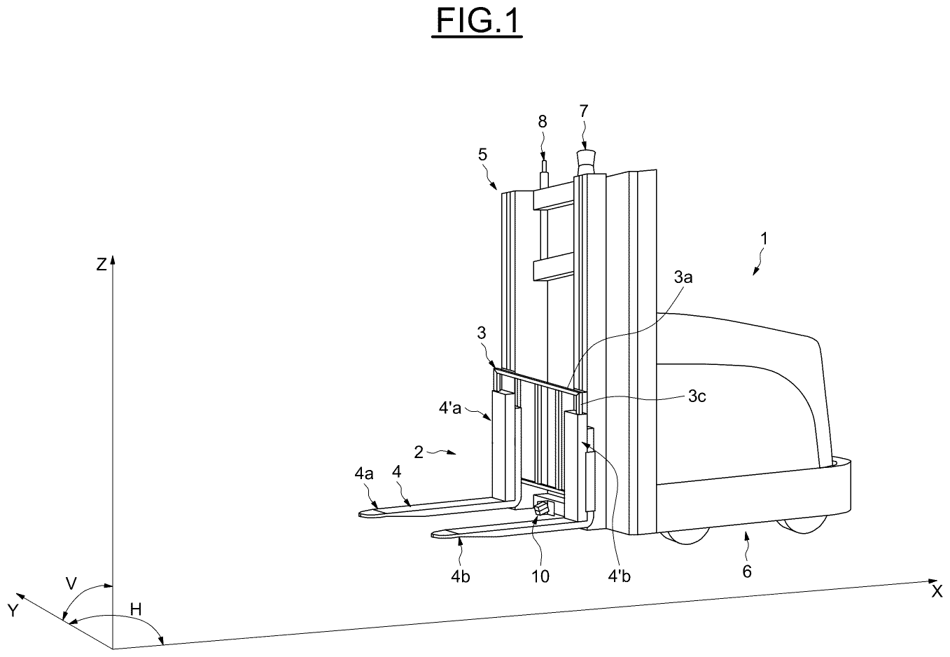

FIG. 1 depicts the main elements of an autonomous forklift 1 according to one embodiment of the invention.

The architecture of the forklift 1 is given by way of example and does not limit the invention to the architectural configuration depicted alone. It will be understood that the invention also relates to forklifts designed to operate in manual mode and which have been adapted to enable a second autonomous operating mode.

The autonomous forklift 1 illustrated in FIG. 1 comprises a lifting member 2 comprising a carriage 3 that bears a fork 4 comprising two arms 4a, 4b that are spaced apart laterally and extend towards the front of the forklift. As a variant, the fork 4 could comprise just one arm.

The carriage 3 forms a frame. The carriage 3 is provided with a horizontal upper crossmember 3a, and two arms 3b, 3c extending the upper crossmember 3a vertically downwards.

The fork 4 also comprises two uprights 4′a, 4′b, which are fastened to the carriage 3 and each bear one of the arms 4a, 4b. Each of uprights 4′a, 4′b is fastened to one of the arms 3b, 3c of the carriage.

The arms 4a, 4b of the fork are generally used for insertion into entry openings provided in the transport pallets bearing the loads to be lifted. The uprights 4′a, 4′b allow the arms 4a, 4b to be raised so that a pallet to be transported or another type of load can be lifted and so that a pallet or another type of load can be positioned or collected at height.

The fork 4 can move in translation in a vertical plane V defined by the carriage 3, along a vertical mast 5 of the forklift. The uprights 4′a, 4′b can slide along the mast 5. The arms 4a, 4b of the fork can move between an uppermost position and a lowermost position that is illustrated in FIG. 1 and that corresponds to a running position. In the lowermost position, the arms 4a, 4b are situated at a distance from the ground.

The longitudinal axes of the arms 4a, 4b are parallel. These longitudinal axes are oriented parallel to a horizontal axis X and define a horizontal plane H referred to as the lifting plane. The arms 4a, 4b of the fork 4 are perpendicular to the vertical plane V. The arms 4a, 4b of the fork 4 can preferably also move laterally relative to each other.

As a variant, the arms 4a, 4b could also be telescopic or retractable and/or able to be oriented angularly about their longitudinal axis.

As is known per se, the forklift 1 is provided with a drive system 6 enabling the forklift 1 to move. The drive system comprises at least one electric motor or combustion engine (not shown) providing drive to the wheels of the forklift 1.

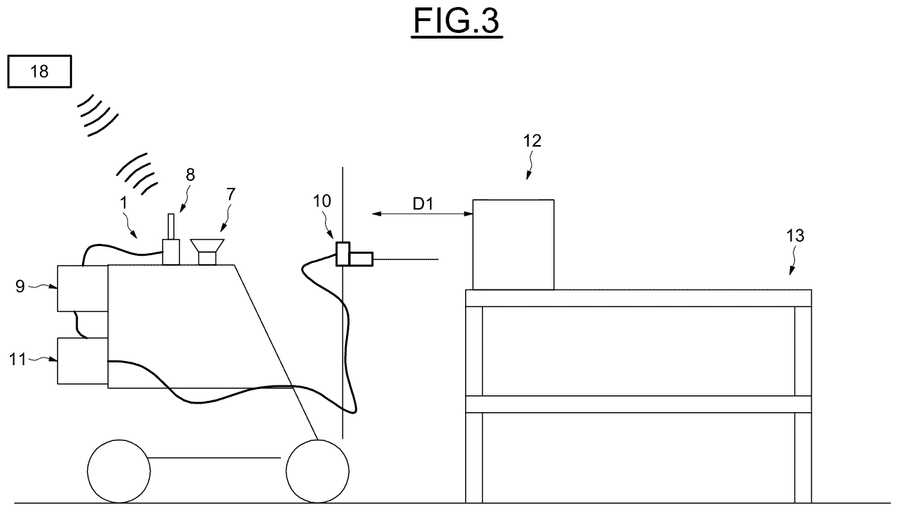

The forklift 1 is also provided with an on-board locator device 7, an on-board wireless telecommunication device 8 and an on-board control unit 9 (FIG. 3) receiving information from the locator device 7 and from the wireless telecommunication device 8 in order to autonomously command the movement of the forklift.

The forklift 1 is also provided with at least one 3D camera 10 for measuring time of flight (TOF), and an associated command and digital image processing module 11 (FIG. 3), referred to as the vision module, which commands the capturing of images by the 3D camera and receives and interprets the images captured by the 3D camera. In the remainder of the description, the module 11 will be referred to as the vision module.

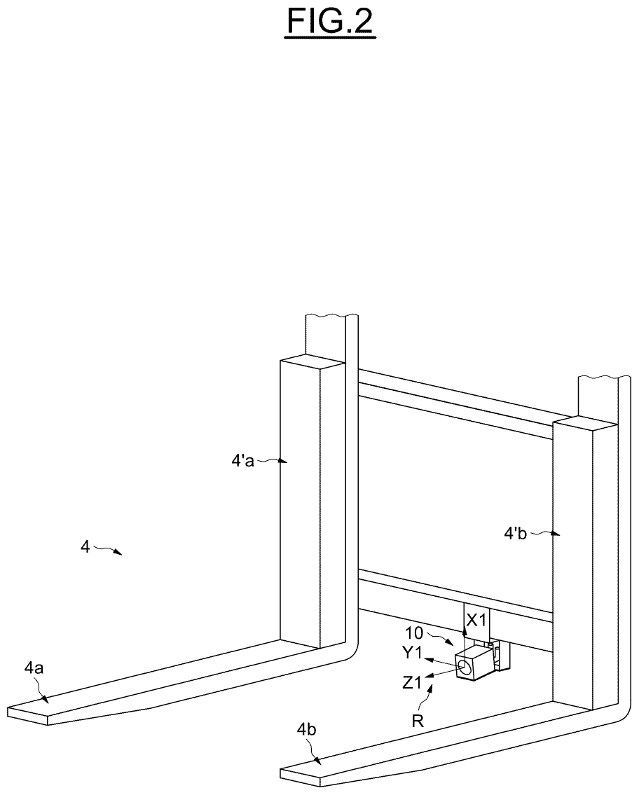

As is known per se, the 3D camera 10 is able to capture an image of an object and render a point cloud of relative coordinates measured with respect to a frame of reference associated with the 3D camera. The frame of reference associated with the 3D camera 10 comprises a coordinate system R made up of three orthogonal axes X1, Y1, Z1, as illustrated in FIG. 2. Here, the axis Z1 of the coordinate system is oriented along the line of sight of the 3D camera 10, and the axis Y1 of the coordinate system is oriented along a horizontal axis Y perpendicular to the line of sight of the 3D camera 10. A 3D camera is able to measure distances along all three axes of the coordinate system associated therewith. For example, as illustrated, the horizontal, vertical or depth offset relative to the 3D camera 10 is measured along the axes Y1, X1 or Z1 respectively.

The 3D camera 10 is separate from the locator device 7. Here, the 3D camera 10 is separate from the vision module 11. Alternatively, the 3D camera 10 and the vision module 11 could form a single assembly.

The control unit 9 comprises the hardware and software for commanding the operation of the drive system 6 on the basis of the information received from the locator device 7 and the telecommunication device 8.

The control unit 9 also commands the operation of the drive system 6 on the basis of the data from the vision module 11 and is configured to communicate therewith. Alternatively, the vision module 11 could be integrated into the control unit 9. The control unit 9 also makes it possible to command the autonomous movement of the lifting member 2.

As illustrated in FIGS. 1 and 2, the 3D camera 10 is centred relative to the fork 4 and its line of sight is oriented forwards along a longitudinal axis of the forklift 1. The 3D camera 10 is fastened to the carriage 3 at a constant height relative to the lifting plane H and without any possibility of moving relative to said carriage. The 3D camera 10 is able to move conjointly with the fork 4. Here, the 3D camera 10 is fastened to the lower part of the carriage 3 above the lifting plane H. In some variants (not shown), the 3D camera 10 can be fastened to the carriage 3 level with the lifting plane H or below said plane.

As described in greater detail below, the 3D camera 10 is able to capture images of the environment in front of the forklift 1, in order to determine the actual dimension of the loads to be lifted and transported by the forklift.

The wireless telecommunication device 8 is configured to communicate with the control unit 9 and with a computerized warehouse management system (WMS) 18 that is remote from the forklift 1 and intended to manage the operations of a storage warehouse and command a fleet of forklifts 1.

Each forklift 1 receives, by means of the telecommunication device 8, information in the form of periodic electronic messages sent by the WMS 18 regarding missions that are assigned to it relating to journeys to be made and loads to be transported. Each forklift 1 is capable of sending the WMS 18 electronic messages representing the status of the missions assigned to it. A forklift 1 can for example report an error encountered during the performance of a mission by sending an error code.

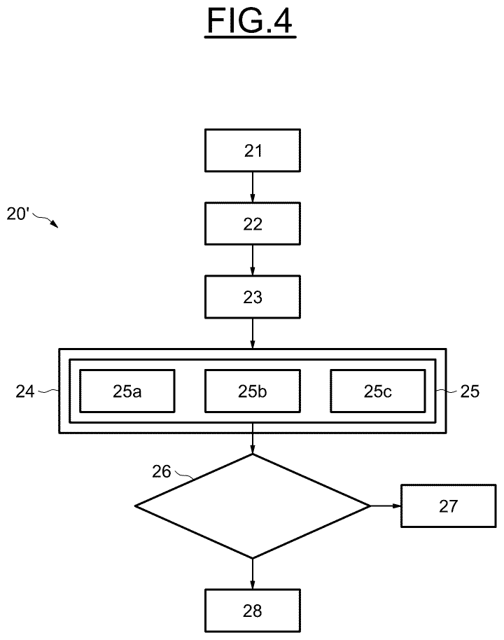

A method 20 for checking the safety of the picking of a load according to the invention will now be described with reference to FIG. 4. In the method described below, the load is annular. An annular load generally comprises a support consisting of a hollow cylindrical core, generally provided with solid or spoked circular flanges, intended to receive a wire or cable that is wound around the core. Alternatively, an annular load can be a tyre.

The method 20 starts with a prior receiving step 21 in which the wireless telecommunication device 8 of the forklift receives an instruction relating to a load to be transported, constituting a mission assigned to the forklift 1 by the WMS 18. The instruction comprises information relating to the type of load to be transported, the dimensions of the load, the current position of the load, and the destination thereof.

Particularly with regard to the dimensions of the annular load, the instruction received can for example comprise the theoretical value of the outer diameter, the theoretical value of the inner diameter and/or the theoretical value of the depth. It will be understood that ideally, the theoretical value of each dimension of a given load should match the actual value of this dimension. However, it is possible for the theoretical value received not to match the actual value of the load present in situ, which can lead to the risk of an accident.

The information received, in particular the information relating to the dimensions of the load to be transported, is stored in a memory of the forklift 1.

During the next movement step 22, the control unit 9 commands the operation of the forklift 1 to make it move closer to the shelving 13 and to raise the arms of the fork 4 in order to position them relative to the load 12 to be lifted. The forklift 1 is commanded by the control unit 9 on the basis of the data from the locator device 7 and the instruction received in the receiving step 21.

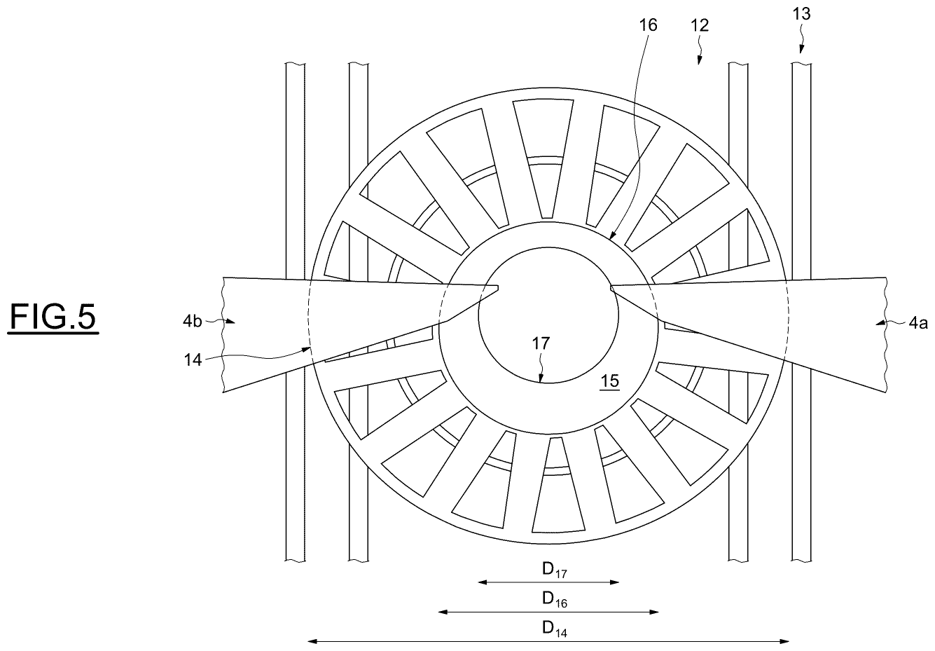

The method 20 continues with a step 23 of acquiring at least one image of the load 12 by means of the 3D camera 10, which is commanded by the vision module 11. The image is acquired at a predefined distance D1 (FIG. 3) from the load 12. When the forklift is situated at this predefined distance D1, the control unit 9 stops the forklift 1 and sends an image acquisition request to the vision module 11, which commands the capturing of images by the associated 3D camera 10. The 3D camera 10 thus captures at least one image of the load 12 situated in front of the forklift 1 and sends it to the vision module 11. A simplified example of a captured image of an annular load is illustrated in FIG. 5. The images captured by the 3D camera 10 render a point cloud of coordinates X1, Y1, Z1 in the coordinate system R associated with the 3D camera 10.

After the acquisition step 23, the method continues with a step 24 of determining the actual value of each dimension received with the instruction from the WMS 18, that is, the value in reality of each dimension for which the forklift received a theoretical value in the receiving step 21. The actual value is determined on the basis of at least one image that is obtained in the acquisition step 23.

The determination step 24 comprises a step 25 of digitally processing the images obtained, carried out by the vision module 11. It should be noted that the digital processing of the images can start as soon as the image captured by the 3D camera 10 is made available to the vision module 11.

The digital processing step 25 comprises a sub-step 25b of calculating the dimensions of the load 12 actually present on the shelving 13.

For example, the digital processing step comprises a sub-step 25a of detecting circles 14, 16 located on a front face of the load 12, and a circle 17 located on a rear face of the load 12 (FIG. 5).

The circles are detected such that the circle 14 is the circle that is observed on the front face of the load and corresponds to the outer surface of the load 12, and the circles 16, 17 are respectively the circles that are observed on the front face and the rear face thereof and correspond to the inner surface of the load 12. The circles 14, 16 and 17 are detected using known circle detection methods, for example the Hough transform method.

As stated previously, the digital processing step comprises a sub-step 25b of calculating the actual value of the dimensions of the load.

In this sub-step, the actual outer and inner diameters of the load are considered to be equal to the diameters D₁₄, D₁₆ (FIG. 5) of the outer circle 14 and inner circle 16 that are observed on the front face of the load. During this sub-step 25b, the diameter D₁₇ of the inner circle 17 is also determined. The value of the diameter D₁₇ is less than the value of the diameter D₁₆ due to the vanishing angle of the image.

In this sub-step 35, the actual value of the depth P of the load is calculated on the basis of the diameter values D₁₆ and D₁₇ of the circles 16, 17 determined in sub-step 25a of detecting circles, and the value of the distance d between the front face of the annular load and the 3D camera 10 that is determined thereby, by applying the following equation:

$$P = d \times \frac{{D}_{16} - {D}_{17}}{{D}_{17}} \qquad ( Eq . 1 )$$

Alternatively, in another embodiment, used for example when the contrast between the front and rear faces of the load 12 is insufficient, the actual value of the depth P of the annular load is calculated as being equal to the maximum difference between the coordinates of the points of the inner surface 15 of the annular load 12, between the circles 16 and 17, said difference being measured along the axis of the coordinate system R oriented along the line of sight of the 3D camera 10.

After the determination of the actual values of the load by the vision module 11, the control unit 9 has information relating to the dimensions of the load obtained through two separate channels, namely the vision module 11 and the WMS 18.

With reference once more to FIG. 4, after the determination step 24, the method continues with a step 26 of comparing the actual values determined in the determination step 24 and theoretical values of the dimensions of the load received in step 21.

In this instance, in the exemplary embodiment described, the actual values of the outer diameter, the inner diameter and the depth of the load are compared with the corresponding theoretical values. Alternatively, it could be possible to determine only one or two of these actual values of the load in view of the comparison step 26.

During the comparison step 26, if the difference between the actual value and the theoretical value of one of the dimensions of the load is greater, as an absolute value, than a predefined associated limit value, the control unit 9 commands the forklift 1 to stop for correction by an operator (step 27).

This limit value can be determined according to the permissible tolerances relative to the safety requirements for lifting and transport operations. The limit value can be specific to each dimension of the load in question.

During step 27 of stopping the forklift, the control unit 9 can send the WMS 18 an error message representing the error encountered.

Conversely, if the actual values match the associated theoretical values to within the limit values, the control unit of the forklift controls the lifting and transport operation (step 28).

This lifting and transport operation can be carried out according to a predetermined lifting and transport scenario that is stored in the control unit 9 of the forklift and comprises safety parameters specific to the theoretical dimensions of the load. For example, the safety parameters define which aisles or bays of the warehouse the forklift can move around in on the basis of the dimensions of the load.

Alternatively, before controlling the lifting and transport operation, the control unit 9 can modify the safety parameters on the basis of the actual dimensions of the load and then carry out the control according to the lifting and transport scenario with the modified safety parameters.

In the exemplary embodiment described above, the step 23 of acquiring one or more images is carried out at the distance D1 from the load 12 only. Alternatively, the acquisition step 23 can comprise a first sub-step of acquisition at the distance D1, followed by a second sub-step of acquisition at a shorter distance D2 from the load, which therefore occurs after the forklift has advanced.

This two-stage acquisition can be beneficial for loads with large dimensions, in particular annular loads for which the viewing angle of the 3D camera 10 might be too small to capture both the inner surface and the outer surface of the load. In this case, the first acquisition sub-step is carried out so that the actual values of the outer diameter and the inner diameter of the load can be calculated, and the second acquisition sub-step is carried out so that the actual value of the depth of the load 12 can be calculated.

In the exemplary embodiment illustrated, the digital processing step 25 comprises a prior sub-step 25c of filtering points. This sub-step 25c is carried out before any other sub-step of the digital processing step 25 and makes it possible to reduce the amount of data to be processed by filtering the points of the images obtained in the acquisition step in order to keep only the points that form part of a region of particular interest. For example, the inner surface 15 of the annular load 12 can constitute a region of particular interest (FIG. 5). By limiting the calculations to the reduced areas of the region of particular interest, the method obtains results more quickly without adversely affecting the quality thereof. By limiting the data to the regions of interest, the size of the memory required for the vision module 11 is also reduced. Alternatively, this filtering sub-step 25c could be omitted.

In the exemplary embodiment described, the step 24 of determining the actual values of the dimensions of the load is carried out by the digital processing 25 of the images obtained by the vision module 11.

In an alternative embodiment, the determination step 24 could comprise a step of reading a bar code on said image obtained in the acquisition step 23, followed by a step of extracting an actual value of the or each dimension under consideration of the load from a table contained in the memory of the forklift on the basis of the bar code read.

In addition, the exemplary embodiment of the method has been described with an annular load. The load can be a palletized load without departing from the scope of the invention. “Palletized load” is given to mean a pallet bearing a load. A pallet is a platform that generally comprises a board supported by blocks, or two boards connected by blocks. A pallet can also be provided with feet supporting the platform.

For a palletized load, the dimensions taken into account can be the height, the depth and/or the width of the load taken alone.

For example, the digital processing step can comprise a sub-step of detecting the front face of the load and a bottom face of the load by using conventional computer vision algorithms. The dimensions relating to the width and the height of the load are then calculated on the basis of the images of the front face, while the dimensions relating to the depth are calculated on the basis of the images of the bottom face.

1.-11. (canceled)

12. A method for lifting and transporting a load using an autonomous forklift comprising a vertically movable fork provided with at least one arm, the method comprising:
a step of the forklift receiving an assigned mission to move the load to be lifted and transported that comprises a theoretical value of at least one dimension of the load;
a step of moving the autonomous forklift so that the autonomous forklift is in front of the load to be lifted and transported;
a step of acquiring at least one image of the load by means of at least one camera fastened to the autonomous forklift centered relative to the vertically movable fork and having a line of sight oriented forward along a longitudinal axis of the forklift;
a step of determining an actual value of the dimension of the load on a basis of the image obtained in the acquisition step;
a step of comparing the actual value of the dimension of the load determined in the determination step and the theoretical value of the dimension of the load received in the receiving step; and
a step of stopping the forklift if a difference between the actual value of the dimension and the theoretical value of the dimension is greater, as an absolute value, than a predefined limit value, or
a step of lifting and transporting the load if the difference between the actual value of the dimension and the theoretical value of the dimension is less than or equal to, as an absolute value, the predefined limit value.

13. The method according to claim 12, wherein the at least one camera is a 3D camera rendering a point cloud of coordinates measured in a coordinate system associated with the 3D camera, and
wherein the determination step comprises a step of digitally processing the image obtained in the acquisition step that comprises a sub-step of calculating the actual value of the dimension of the load.

14. The method according to claim 12, wherein the determination step comprises a step of reading a bar code on the image obtained in the acquisition step, and a step of extracting the actual value of the dimension of the load from a table contained in a memory of the forklift on a basis of the bar code read.

15. The method according to claim 13, wherein:
the load to be lifted and transported is annular,
the mission assigned in the receiving step comprises theoretical values of a depth P and an outer diameter of the annular load,
the digital processing step comprises sub-steps of calculating the actual values of the depth P and the outer diameter of the annular load,
the comparison step comprises comparing the actual value and the theoretical value of the depth P of the annular load, and comparing the actual value and the theoretical value of the outer diameter of the annular load, and
the step of stopping the forklift is carried out if the difference between at least one of the actual values and a theoretical value is greater, as an absolute value, than the predefined limit value.

16. The method according to claim 15, wherein:
the step of digitally processing the image obtained in the acquisition step comprises a sub-step of detecting a first inner circle located on a front face of the annular load and corresponding to an inner diameter of the annular load, and detecting a second inner circle located on a rear face of the annular load and corresponding to an inner surface of the annular load,
the actual value of the depth of the annular load is calculated on a basis of the diameter D₁₆ of the first inner circle, the diameter D₁₇ of the second inner circle, and a distance d between the 3D camera and the front face of the annular load, using the following equation:
$$P = d \times \frac{{D}_{16} - {D}_{17}}{{D}_{17}} \qquad ( Eq . 1 )$$

17. The method according to claim 16, wherein the actual value of the depth P of the annular load is equal to a maximum difference between the coordinates of the points of an inner surface of the annular load between the inner circles, the difference being measured along an axis of the coordinate system oriented along the line of sight of the 3D camera.

18. The method according to claim 15, wherein the step of digitally processing the image obtained in the acquisition step comprises a sub-step of detecting a circle located on a front face of the annular load and corresponding to the outer diameter of the annular load.

19. The method according to claim 15, wherein the acquisition step comprises the following successive sub-steps:
a first sub-step of acquiring at least one image;
a sub-step of advancing the forklift toward the annular load by a predefined distance; and
a second sub-step of acquiring at least one image carried out when the forklift has covered the predefined distance, and
wherein the sub-step of calculating the actual value of the outer diameter of the annular load is carried out on a basis of the image obtained in the first acquisition sub-step, and the sub-step of calculating the actual value of the depth P of the annular load is carried out on a basis of the image obtained in the second acquisition sub-step.

20. The method according to claim 13, wherein the digital processing step comprises a sub-step of filtering the image obtained in the acquisition step that is carried out before any other sub-step of the digital processing step.

21. The method according to claim 12, wherein the step of acquiring the image of the load is carried out by a single 3D camera.

22. An autonomous forklift comprising the vertically movable fork provided with at least one arm, at least one 3D camera for acquiring at least one point cloud data image, the at least one 3D camera being fastened to the autonomous forklift centered relative to the vertically movable fork and having a line of sight oriented forward along a longitudinal axis of the autonomous forklift, a command and digital image processing module associated with the at least one 3D camera, a wireless telecommunication device, and a unit for controlling the autonomous forklift configured to implement the method according to claim 12.
